(19) United States
(12) Patent Application Publication
(10) Pub. No.: US 2008/0260372 A1
(43) Pub. Date: Oct. 23, 2008

(54) Flash Apparatus and Portable Terminal Having the Same

(76) Inventor: Kyung Ho Shin, Gwangju (KR)

Correspondence Address: BIRCH STEWART KOLASCH & BIRCH, PO BOX 747, FALLS CHURCH, VA, 22040-0747, US

(21) Appl. No.: 12/067,034

(22) PCT Filed: Sep. 6, 2007
(86) PCT No.: PCT/KR2007/004295

§ 371 Date: Mar. 14, 2008

(30) Foreign Application Priority Data
Sep. 12, 2006 (KR) 10-2006-0088298

(51) Int. Cl. G03B 15/03; G03B 15/02

(52) U.S. Cl. 396/176; 362/16; 362/11

(57) ABSTRACT

Provided are a flash apparatus and a portable terminal having the same. The flash apparatus includes a main body, a light emitting diode, a lens, a lens housing, and a lens transfer part. The main body has an opening part, and the light emitting diode is disposed in the opening part. The lens is disposed on a light emitting path of the light emitting diode. The lens housing is disposed in the inside of the opening part to fix the lens, and the lens transfer part moves the lens housing in one of an upper direction and a lower direction.

### TECHNICAL FIELD

Embodiments relate to a flash apparatus of a camera, and a portable terminal having the same.

### BACKGROUND ART

With development of multimedia technology and data storage technology, a portable terminal such as a cellular phone and a personal digital assistant (PDA) in which a camera is mounted, and a personal is widely used.

The camera, which is an apparatus converting an optical image into an electrical image, can take a image a still image and a moving image. The camera requires a flash apparatus providing a flash function in the case where surroundings are dark. The flash apparatus is an indispensable apparatus for a camera of a portable terminal.

### DISCLOSURE OF INVENTION

### Technical Problem

Embodiments provide a flash apparatus using a light emitting diode and a portable terminal having the same.

Embodiments provide a flash apparatus that can control a beam illumination angle and a portable terminal having the same.

### Technical Solution

An embodiment provides a flash apparatus comprising: a main body comprising an opening part; a light emitting diode in the opening part; a lens on a light emitting path of the light emitting diode; a lens housing comprising the lens in an inside of the opening part; and a lens transfer part moving the lens housing in one of an upper direction and a lower direction.

An embodiment provides a flash apparatus of a camera, comprising: a main body comprising an opening part; a light emitting diode emitting light in the opening part; a lens housing comprising a lens, the lens housing being provided inside the opening part; and a lens transfer part controlling an illumination angle of light emitted from the lens.

An embodiment provides a portable terminal comprising: a camera unit; and a flash apparatus on one side of the camera unit; wherein the flash apparatus comprising: an opening part in the main body; a light emitting diode in the opening part; a lens on a light emitting path of the light emitting diode; a lens housing fixing the lens in an inside of the opening part; and a lens transfer part moving the lens housing in one of an upper direction and a lower direction.

The details of one or more embodiments are set forth in the accompanying drawings and the description below. Other features will be apparent from the description and drawings, and from the claims.

### ADVANTAGEOUS EFFECTS

A flash apparatus and a portable terminal having the same according to an embodiment can be changed the focal distance of a lens, so that a beam illumination angle and brightness can be improved.

Also, light emitted from a light emitting diode is reflected, so that a light loss can be reduced.

Also, image quality can be improved by controlling a beam illumination angle during a shooting mode of a camera under a dark environment.

### BRIEF DESCRIPTION OF THE DRAWINGS

FIG. 1 is a perspective view of a backside of a portable terminal according to an embodiment.

FIGS. 2 and 3 are side cross-sectional views of a flash apparatus according to a first embodiment.

FIGS. 4 and 5 are side cross-sectional views of a flash apparatus according to a second embodiment.

FIG. 6 is a side cross-sectional view of a flash apparatus according to a third embodiment.

### BEST MODE FOR CARRYING OUT THE INVENTION

Reference will now be made in detail to the embodiments of the present disclosure, examples of which are illustrated in the accompanying drawings.

FIG. 1 is a perspective view of a backside of a portable terminal according to an embodiment.

Referring to FIG. 1, examples of the portable terminal 10 can include a portable telephone, a digital camera, and a portable multimedia apparatus, for example. Also, the portable terminal 10 can be realized in one of a bar type terminal, a slide type terminal, and a folder type terminal, but is not limited thereto.

A main body 120 of the portable terminal 10 includes a camera unit 20 and a flash apparatus 100. The camera unit 20 is installed in the main body 120, and the flash apparatus 100 is installed on one side of the camera unit 20.

The camera unit 20 includes a lens 21 and an image sensor (not shown). The image sensor converts optical signals of an object provided through the lens 21 into electrical signals, and obtains image signals of the object from the converted electrical signals.

The flash apparatus 100 illuminates light generated from the inside to the outside when an outside environment is dark. The flash apparatus 100 can illuminate light from a light source, for example, a light emitting diode. The flash apparatus 100 performs as a light of the camera unit 20 by illuminating light to a shooting area during a camera mode and a dark environment.

The flash apparatus 100 includes a light source (not shown), a lens 130, and a lens housing 140. The lens 13 is a convex lens and is fixed to the lens housing 140.

The lens housing 140 moves vertically up or down together with the lens 130 to control a beam illumination angle. That is, the lens housing 140 controls a beam illumination angle by controlling a distance between the lens 130 and a light source.

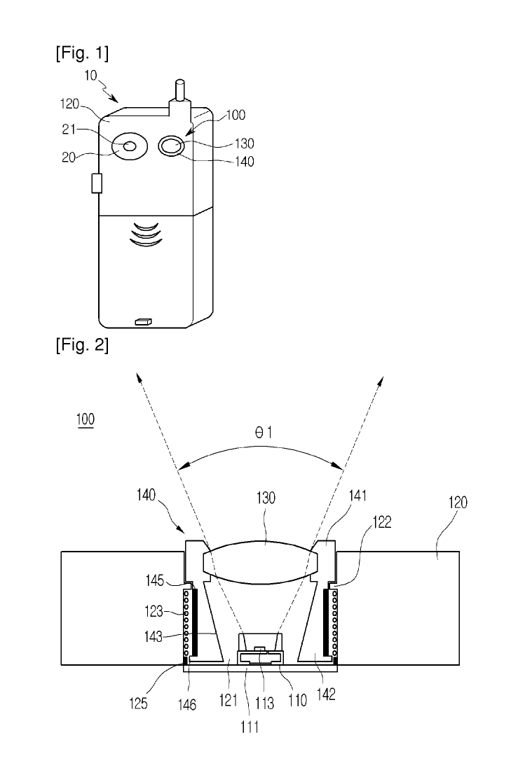

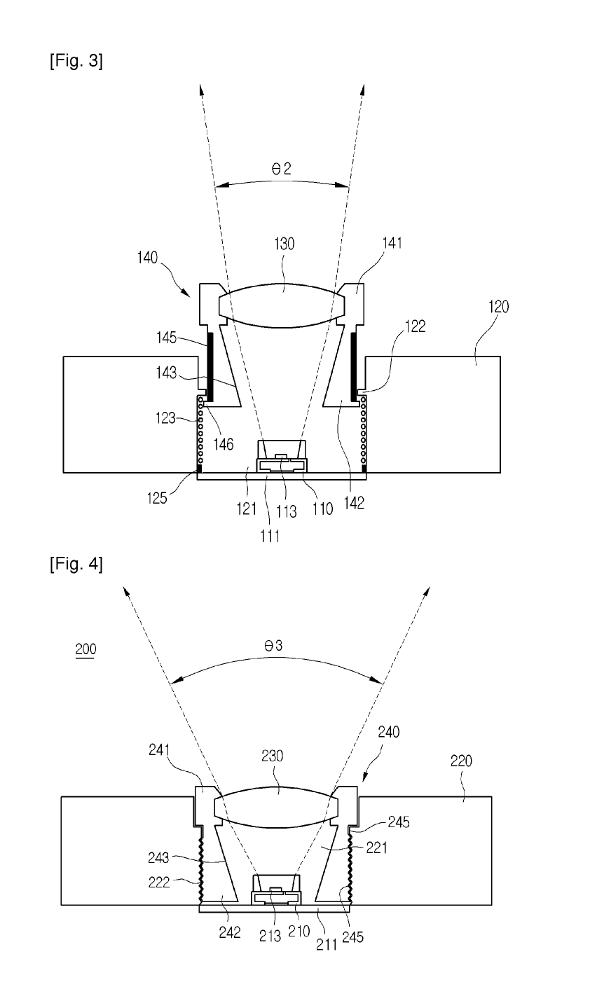

FIGS. 2 and 3 are side cross-sectional views of a flash apparatus according to a first embodiment. FIG. 2 illustrates an initial state of the flash apparatus, and FIG. 3 illustrates a controlled beam illumination angle of the flash apparatus.

Referring to FIGS. 2 and 3, the flash apparatus 100 includes a light emitting diode 110, a main body 120, the lens 130, the lens housing 140, and a coil 123 and a magnet 145 as a lens transfer part.

The light emitting diode 110 includes a semiconductor light emitting device having a junction structure such as p-n, n-p, n-p-n, and p-n-p, and emits light through recombination of injected electrons and holes. This light emitting diode 110 can be realized in a white light emitting diode by packaging having at least one light emitting diode chips 113.

The light emitting diode 110 is disposed in an opening part 121 of the main body 120 and connected to a substrate 111. Here, the substrate 111 can be realized in one of a camera module substrate, a main substrate of a terminal, and a substrate for a flash.

The lens housing 140 is coupled to the opening part 121 of the main body 120. Here, in the case where the opening part 121 has a circular shape, the lens housing 140 can be formed in a cylindrical shape.

The lens housing 140 includes a lens holder 141 at the upper portion and a transfer guide 142 at the lower portion. The lens 130 is fixed in the lens holder 141. The transfer guide 142 is integrally formed under the lens holder 141 and vertically moves along the opening part 121. A reflection plane 143 having an inclined structure is formed on the inner surface of the transfer guide 142. The reflection plane 143 reflects light emitted from the light emitting diode 110 toward the lens 130 to reduce a light loss. Here, a reflection material (e.g., Al) can be coated or a reflection sheet can be attached on the reflection plane 143. Also, the reflection plane 143 can be formed of a reflection material.

Also, the lens transfer part is installed on the outer surface of the transfer guide 142. The lens transfer part includes the coil 123 and the magnet 145 to use electromagnetic force generated between the coil 123 and the magnet 145.

The magnet 145 can be realized in a permanent magnet. The magnet 145 is disposed along the outer periphery of the transfer guide 142 of the lens housing 140. The coil 123 is disposed on the inner periphery of the opening part 121 to correspond to the magnet 145. The coil 123 is wired in a horizontal direction.

When a current is supplied to the coil 123, electromagnetic force is generated between the coil 123 and the magnet 145. The generated electromagnetic force moves the magnet 145 in a vertically upward direction. At this point, the lens housing 140 and the lens 130 move in the vertically upward direction together with the magnet 145. Here, the coil 123 and the magnet 145 operate in accordance with Fleming's rule. The installation positions of the coil 123 and the magnet 145 can change.

Here, a hooking threshold 146 is formed at the lower outer peripheral end of the lens housing 140, and a stopping threshold 122 is formed at the upper inner peripheral end of the opening part 121 to correspond to the hooking threshold 146. The stopping threshold 122 allows the hooking threshold 146 to be hooked when the lens housing 140 moves to prevent the lens housing 140 from being detached to an upward direction.

Also, a holding magnet 125 is disposed at the lower inner peripheral end of the opening part 121. Attractive force is generated between the holding magnet 125 and the magnet 145. The attractive force prevents the lens housing 140 from being detached from its initial position. At this point, a current may not be applied to the coil 123. Here, in the case where the holding magnet 125 is not installed, the lens housing 140 can be held at the initial position by electromagnetic force between the coil 123 and the magnet 145 by applying a constant current on the coil 123.

The operation of the flash apparatus 100 is described below with reference to FIGS. 2 and 3.

Referring to FIG. 2, initially, light emitted from the light emitting diode 110 is illuminated at a first illumination angle θ1 through the lens 130 of the lens housing 140. Since the distance between the lens 130 and the light emitting diode 110 is close, light emitted from the light emitting diode 110 is illuminated to a region corresponding to the first illumination angle θ1 through the lens 130.

At this point, the initial position of the lens housing 140 can be held by attractive force between the holding magnet 125 and the magnet 145.

Also, in the case where an outside environment is dark or a bean illumination angle needs to be controlled, when a current is supplied to the coil 123, the magnet 145, the lens housing 140, and the lens 130 is moved in a vertically upward direction through electromagnetic force generated between the coil 123 and the magnet 145. Here, the movement distance and the movement direction of the lens housing 140 can be controlled according to the size and direction of the current applied to the coil 123. Also, the size of the current initially applied to the coil 123 can be greater than that of the above-described attractive force.

The lens housing 140 moves in a vertically upward direction due to the interaction between the coil 123 and the magnet 145, so that the distance between the lens 130 and the light emitting diode 110 gradually increases and the bean illumination angle θ1 of the lens 130 gradually reduces.

When the gap between the lens housing 140 and the light emitting diode 110 is maximized as illustrated in FIG. 3, light emitted from the light emitting diode 110 is illuminated to a region corresponding to a second illumination angle θ2 through the lens 130, so that a light-illuminated region can be minimized and the brightness of the region can be maximized.

When the lens housing 140 moves in the upper direction, the hooking threshold 146 formed at the lower outer peripheral end of the lens housing 140 is hooked at the stopping threshold 122 formed at the upper inner peripheral end of the opening part 121, so that upward detachment of the lens housing 140 is prevented.

Meanwhile, to end a shooting mode of the camera or to widen the bean illumination angle again, the lens 130 can be reset to the first illumination angle θ1 as illustrate in FIG. 2. At this point, when the current supplied to the coil 123 is reversed, the lens housing 140 is moved in a vertically downward direction due to electromagnetic force between the coil 123 and the magnet 145, thereby moving to the initial position.

As described above, as the lens housing 140 moves in the vertically upward/downward directions due to the electromagnetic force between the coil 123 and the magnet 145, the distance between the lens 130 and the light emitting diode 110 can be controlled, and beam illumination angles θ1-θ2 of light illuminated to the outside through the lens 130 can be controlled. Accordingly, the brightness of light illuminated through the flash apparatus can be controlled.

Also, the reflection plane 143 of the lens housing 140 reflects light emitted from the light emitting diode 110 toward the lens 130, thereby increasing an amount of light passing through the lens 130.

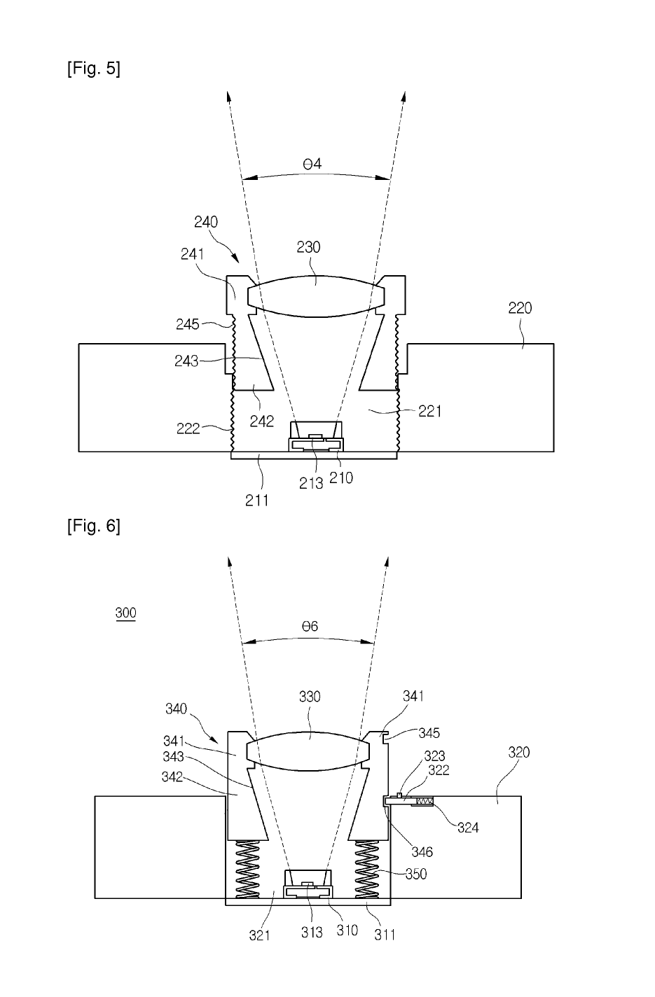

FIGS. 4 and 5 are views illustrating a flash apparatus of a portable terminal according to a second embodiment. In descriptions of the second embodiment, descriptions of the same parts as those of the first embodiment are omitted.

Referring to FIGS. 4 and 5, a lens transfer part of a flash apparatus 200 is realized in screw threads 222 and 245.

The screw threads 222 and 245 include a first screw thread 222 formed in the inner periphery of the opening part of a main body 220, and a second screw thread 245 formed in the outer periphery of the lens housing 240. These first and second screw threads 222 and 245 are coupled to each other in a screw type.

Referring to FIG. 4, the lens 230 is initially set to a third illumination angle θ3. Also, to control an illumination angle to a narrower angle than the third illumination angle θ3, the lens housing 240 is rotated clockwise. When the lens housing 240 is rotated clockwise, the lens housing 240 is moved in the vertically upward direction. At this point, the third illumination angle θ3 of the lens 230 gradually reduces depending on a rotation degree of the lens housing 240.

Also, in the case where the lens housing 240 does not rotate clockwise further as illustrated in FIG. 5, the lens 230 is set to a fourth illumination angle θ4.

In other words, since the distance between the lens 230 and the light emitting diode 210 is minimum at the initial position of the lens housing 240 as illustrated in FIG. 4, light that passes through the lens 230 is illuminated in the third illumination angle θ3. Also, when the distance between the lens housing 240 and the light emitting diode 210 is maximized as illustrated in FIG. 5, light that passes through the lens 230 is illuminated in the fourth illumination angle θ4. At this point, since light emitted from the light emitting diode 210 is illuminated to a narrow region through the lens 230, the brightness of the narrow region is maximized.

Also, a reflection plane 243 of a transfer guide 242 of the lens housing 240 reflects light generated from the inside toward the lens 230 to increase an amount of light that passes through the lens 230.

Meanwhile, when the lens housing 240 is rotated counterclockwise, the fourth illumination angle θ4 of the lens 230 gradually widens. Also, when the lens housing 240 is rotated counterclockwise completely, the lens housing 240 is moved to the initial position and the lens 230 is set to the third illumination angle θ3 as illustrated in FIG. 4.

Here, according to the second embodiment, the distance between the lens 230 and the light emitting diode 210 can be freely controlled by rotating the lens housing 240 clockwise or counterclockwise in a screw type. The bean illumination angles θ3-θ4 of the lens 230 can be freely controlled through this distance control.

FIG. 6 is a view of an operation of a flash apparatus according to a third embodiment. In descriptions of the third embodiment, descriptions of the same parts as those of the first embodiment are omitted.

Referring to FIG. 6, a lens transfer part of the flash apparatus 300 can be realized in an elastic spring 350. A single elastic spring 350 or a plurality of elastic spring 350 can be installed between a lens housing 340 and a substrate 311. Also, the modules of elasticity of the elastic spring 350 can be controlled by controlling the thickness of the spring 350 and the interval between spring spirals.

The elastic spring 350 is compressed or extended to move the lens housing 340 and the lens 330 in a vertically upward/downward direction.

The distance between the lens housing 340 and the light emitting diode 310 is maximized by the elastic spring 350, and the light emitted from the light emitting diode 310 is illuminated in a sixth illumination direction θ6 of a lens 330.

Also, a first hooking groove 345 and a second hooking groove 346 are formed at the upper and lower outer peripheral ends of the lens housing 340, and an elastic hooking protrusion 322 is formed at the upper inner peripheral end of the opening part 321. Since the first hooking groove 345 is coupled to the elastic hooking protrusion 322 when the lens housing 340 moves to an initial position, movement of the lens housing 340 toward an upper direction is limited. Also, since the second hooking groove 346 is coupled to the elastic hooking protrusion 322 when the lens housing 340 moves to a maximum position, detachment of the lens housing 340 toward the upper direction is prevented.

At this point, the elastic hooking protrusion 322 is compressed or extended by a compressed spring 324, so that the elastic hooking protrusion 322 can be selectively coupled to the first hooking groove 345 or the second hooking groove 346 formed in the outer periphery of the lens housing 340. Also, since the elastic hooking protrusion 322 can be moved horizontally by a user, the movement of the lens housing 340 can be manually controlled.

As described above, according to the embodiments, a lens is mounted in a lens housing and the lens housing can be moved in vertically up/down directions, so that a beam illumination angle of the lens can be controlled by controlling the distance between the lens and a light emitting diode. Accordingly, brightness of light illuminated to the outside can be controlled by controlling the bean illumination angle.

### INDUSTRIAL APPLICABILITY

In a flash apparatus and a portable terminal according to an embodiment, brightness can be controlled by changing a focal distance of a lens of the flash apparatus to control a bean illumination angle.

Also, light emitted from a light emitting diode is reflected, so that a light loss can reduce.

Also, image quality can be improved by controlling a beam illumination angle during a shooting mode of a camera under a dark environment.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A flash apparatus comprising:
a main body comprising an opening part;
a light emitting diode in the opening part;
a lens on a light emitting path of the light emitting diode;
a lens housing comprising the lens in an inside of the opening part; and
a lens transfer part moving the lens housing in one of an upper direction and a lower direction.

2. The flash apparatus according to claim 1, wherein the light emitting diode comprises at least one white light emitting diode.

3. The flash apparatus according to claim 1, wherein the lens housing comprises a cylindrical shape and comprises a reflection plane on an inner surface of the lens housing, the reflection plane reflecting light generated from the light emitting diode.

4. The flash apparatus according to claim 1, wherein the lens housing comprises a cylindrical shape and comprises a lens holder at an upper portion and a transfer guide under the lens holder, the lens holder fixing the lens, and the transfer guide guiding movement of the lens in one of upper and lower directions in an inside of the opening part.

5. The flash apparatus according to claim 1, wherein the lens transfer part comprises a magnet and a coil facing each other, the magnet being disposed on an outer periphery of the lens housing, and the coil being disposed on an inner periphery of the opening part.

6. The flash apparatus according to claim 1, wherein the lens transfer part comprises screw threads in an outer periphery of the lens housing and an inner periphery of the opening part, the screw threads corresponding to each other.

7. The flash apparatus according to claim 1, wherein the lens transfer part comprises an elastic spring under the lens housing, the lens transfer part being compressed or extended.

8. The flash apparatus according to claim 1, comprising:
a hooking threshold at an upper inner peripheral end of the opening part; and
a stopping threshold at a lower outer peripheral end of the lens housing.

9. The flash apparatus according to claim 1, comprising:
a plurality of hooking grooves in upper and lower outer peripheral ends of the lens housing; and
an elastic protrusion in an inner periphery of the opening part, the elastic protrusion being selectively coupled to the plurality of hooking grooves.

10. A flash apparatus of a camera, the flash apparatus comprising:
a main body comprising an opening part;
a light emitting diode emitting light in the opening part;
a lens housing comprising a lens in an inside the opening part; and
a lens transfer part controlling an illumination angle of light emitted from the lens.

11. The flash apparatus according to claim 10, wherein the lens transfer part moves the lens housing in upper/lower direction.

12. The flash apparatus according to claim 10, wherein the lens transfer part comprises a magnet and a coil facing each other, the magnet being disposed on an outer periphery of the lens housing, and the coil being disposed on an inner periphery of the opening part.

13. The flash apparatus according to claim 10, wherein the lens transfer part comprises screw threads in an outer periphery of the lens housing and an inner periphery of the opening part, the screw threads corresponding to each other.

14. The flash apparatus according to claim 10, wherein the lens transfer part comprises an elastic spring under the lens housing, the lens transfer part being compressed or extended.

15. The flash apparatus according to claim 10, comprising threshold-shaped protrusions at an upper inner peripheral end of the opening part and a lower outer peripheral end of the lens housing, the threshold-shaped protrusions corresponding to each other.

16. The flash apparatus according to claim 10, comprising:
a magnet at an outer periphery of the lens housing;
a coil at an inner periphery of the opening part; and
a holding magnet at a lower inner peripheral end of the opening part, attractive force being applied between the magnet and the holding magnet.

17. The flash apparatus according to claim 14, comprising:
hooking grooves in upper/lower outer peripheral ends of the lens housing; and
an elastic hooking protrusion selectively coupled to the hooking grooves to fix a position of the lens housing, the elastic hooking protrusion being formed at an upper peripheral end of the opening part.

18. A portable terminal comprising:
a camera unit comprising to a main body; and
a flash apparatus on one side of the camera unit;
wherein the flash apparatus comprising:
an opening part in the main body;
a light emitting diode in the opening part;
a lens on a light emitting path of the light emitting diode;
a lens housing fixing the lens in an inside of the opening part; and
a lens transfer part moving the lens housing in one of an upper direction and a lower direction.

19. The portable terminal according to claim 18, wherein the lens transfer part is disposed between the lens housing and the opening part to change a distance between the lens and the light emitting diode, and uses one of electromagnetic force that uses a coil and a magnet, a screw type, and an elastic spring type.

20. The portable terminal according to claim 18, comprising a reflection plane on an inner surface of the lens housing, the reflection plane reflecting light emitted from the light emitting diode toward the lens.
